(19) United States
(12) Patent Application Publication
(10) Pub. No.: US 2009/0048987 A1
(43) Pub. Date: Feb. 19, 2009

(54) System and Method for Optimizing the Loading of Shipping Containers

(76) Inventors: Jeff Sweeney, Atlanta, GA (US); Lorrie Hendrickson, Cumming, GA (US); Scott Ellyson, Decatur, GA (US); Jason Ganim, Dunwoody, GA (US)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/189,409

(22) Filed: Aug. 11, 2008

Related U.S. Application Data
(60) Provisional application No. 60/955,502, filed on Aug. 13, 2007.

(51) Int. Cl. G06Q 30/00; G06Q 10/00

(52) U.S. Cl. 705/400

(57) ABSTRACT

A system and method for optimizing the loading of a shipping container, optimizing freight costs, communicating ordering and shipping constraints to a customer, and continuously updating shipping costs while an order is being built by a customer.

### CLAIM OF PRIORITY

This application claims priority from U.S. Provisional Patent Application Ser. No. 60/955,502, filed on Aug. 13, 2007, which is incorporated herein in its entirety.

### FIELD OF THE INVENTION

This invention relates to a system and method for optimizing the loading of a shipping container and thereby optimizing freight costs, communicating ordering and shipping constraints to a customer, and continuously updating shipping costs while an order is being built by a customer. Particularly, the present invention includes a container software tool that interfaces with a supplier's Enterprise Resource Planning (ERP) software or system in order to determine a item landed price for a particular product delivered to a particular customer at a particular destination and to determine a net landed price for each container order.

### BACKGROUND OF THE INVENTION

Many potential customers are unable to participate in offshore purchasing opportunities due to high minimum shipment quantities, high costs associated in shipping less than a full container load, or a combination of those two constraints. Inefficient configuration of container orders results in high freight costs, and thus profits and/or competitiveness are compromised. Optimizing freight cost through optimization of container loading is particularly important when the freight cost component is a relatively large portion of the overall landed cost of an item or product, and the item landed cost is variable and dynamic according to the ultimate make-up of the container load. Freight cost optimization is time consuming and labor intensive especially when optimizing freight costs for shipping in consolidated containers of multiple SKU's, across multiple product categories, from multiple factories/suppliers to a customer with one or multiple ship-to locations.

In addition to the optimization of container loading and the related optimization of freight costs, a supplier must be able to communicate to customers the complexity of shipping constraints, such as minimum order quantities (MOQ's, which can be dependent on each SKU, on each product category, or on a full order), full carton requirements, palletizing or floor loading, and container load restrictions. Such customer communications is particularly difficult when many of the constraints are variable and dynamic according to the ultimate make-up of the container load.

### SUMMARY OF THE INVENTION

The invention is a system and method for optimizing container loading, thereby optimizing freight costs, for continuously calculating the item landed cost for an item purchased from a supplier and shipped to a customer at a particular location, for continuously calculating the net landed cost of a container order, and communicating shipping constraints to a customer during the process of building an order. When used in connection with the present invention, the term “constraint” refers not only to ordering limitations imposed on the customer, but also to ordering options available to the customer. The system and method employs a container software tool, which can operate as a stand-alone program on a customer's computer or in conjunction with a web-based customer portal connected to the supplier's Enterprise Resource Planning (ERP) software or system. The container software tool provides efficient and effective management of ordering and shipping products, particularly from offshore suppliers. A customer can use the container software tool interactively to configure container orders by following a series of instructions, menus, and selection screens.

A database, within the container software tool or linked to the container software tool via the supplier's ERP system, contains pertinent information related to each item and product category, such as pricing, MOQ, carton quantity, pallet quantity, weight, and cube (space utilization).

The container software tool also has (within itself or linked via the supplier's ERP system) constraints related to various standard shipping containers, such as interior dimensions, unitary pallet capacity, and gross and net weight limits. The constraints can vary by customer's ship-to location due to local rail and road limits applicable to the over-land portion of the freight route.

The container software tool also has reference data (internally or via link to the supplier's ERP system) to automatically tack on and charge for additional services, such as consolidation of multiple product categories from multiple supplier locations, palletization of goods, and cross-docking of goods in order to ship to multiple customer locations upon arrival of the container in the customer's home country.

The container software tool allows multiple users at the customer (at the same or different ship-to locations) to configure an order on the same container, either simultaneously or successively. The container software tool enables multiple users, within an associated group (i.e. a large customer with autonomous divisions or a buying cooperative), to pool orders and to meet minimum shipment thresholds they could not otherwise meet. The container software tool can also assign individual customers or users to recommended buying pools based upon geographic and other shipping efficiency considerations. The container software tool can alert individual customers, via e-mail, within an associated group that an order is being configured and pending shipment at some future date so that additional individual customers or users can add to the order and take part in the pending shipment.

The container software tool communicates the item landed cost of an item and the net landed cost of a container order in real time as the order is being entered and configured by the customer or user. Upon completion, the configured order created by the container software tool becomes the customer's purchase order to the supplier, and the configured order can be sent electronically (via e-mail or EDI) or physically (via mail or facsimile after being printed from the container software tool).

The tool further allows fast and efficient “what if” alternate and iterative order planning scenarios by the customer, to arrive at the optimal combination of product mix and net landed cost for the container order.

Further objects, features and advantages will become apparent upon consideration of the following detailed description of the invention when taken in conjunction with the drawing and the appended claims.

### BRIEF DESCRIPTION OF THE DRAWINGS

FIG. 1 is a block diagram of a spreadsheet implemented system for optimizing container loading and freight costs in accordance with the present invention.

FIG. 2 is a block diagram of a web based system for optimizing container loading and freight costs in accordance with the present invention.

FIG. 3a-d is a flowchart illustrating a method for optimizing container loading, freight costs, and continuously calculating the item landed cost for each item and the net landed cost for each container order in accordance with the present invention.

### DETAILED DESCRIPTION OF THE PREFERRED EMBODIMENT

When a customer orders products or items for containerized shipment from a supplier, the customer must be able to determine the item landed cost for each of the items as well as the net landed cost for the container order. The item landed cost per item equals the sum of the item cost, the item markup, the duty, the freight cost, any consolidation fee, any pallet fee, and any cross-docking fee. The net landed cost for the container order equals the sum of all item landed costs multiplied by the quantity of items for the container order.

Item Landed Cost

Each of the cost elements of the item landed cost is determined as follows by the system and method of the present invention:

The item cost comes from tables extracted from supplier's ERP system. For example, the item cost may be adjusted by currency exchange rates, raw material cost adjustments, or other considerations. For example, based on prior announcements by the supplier, the cost of an item may be dependent on the commodity prices of a particular raw material that makes up a large portion of the item's cost basis.

The item mark up cost comes from a table within the container software tool or from the supplier's ERP system. The markup cost is an assigned value based on the customer's class price level and is usually expressed as a percentage of item cost.

Duty is a calculated value derived from multiplying an import duty percentage (from a table within the container software tool or from the supplier's ERP system) for each item based on the item cost.

The freight cost is calculated dynamically as follows:
Weight and cube (volume) for each item is extracted from a table within the container software tool or from the supplier's ERP system.
Ship-to location (from supplier's port to destination location) costs and mark-ups are extracted from a table within the container software tool or from the supplier's ERP system based on less than a container load (LCL) (by weight and cube) for each type and size of container.
Freight cost defaults to LCL freight cost until total order size hits a trigger point where the total freight cost is equal to or greater than cost of a full container load (FCL) based on the container size selected for the particular container order.
Once the trigger point has been reached, the freight cost is calculated dynamically based on a percentage of the selected container's weight and/or cube capacity occupied by that item.

The pallet fee cost is calculated by dividing the standard cost of a pallet (extracted from a table within the container software tool or from the supplier's ERP system) by the number of items per pallet. The number of items per pallet is calculated based on the number of cartons per pallet and number of pieces per each carton, extracted from a table within the container software tool or from the supplier's ERP system. Total pallet fees are calculated by multiplying a standard pallet cost by the number of pallets used in the selected container.

The consolidation fee is calculated on a per container basis based on business rules for each customer class. A typical consolidation fee may be a flat fee of $500 fee for each new product category after the first product category, with a limit of $1000 for the total consolidation fee per container order. The total consolidation fee is then attributed to each item based upon the item's contribution to the total weight or volume of the container.

The cross docking fee is calculated by taking total handling costs and inland freight costs (based on a ship-to location and customer class—from a table within the container software tool or from the supplier's ERP system) for each partial shipment from the container order and allocating the cross-docking fees based on the item's contribution to the total weight or volume of that partial shipment.

The System Configuration

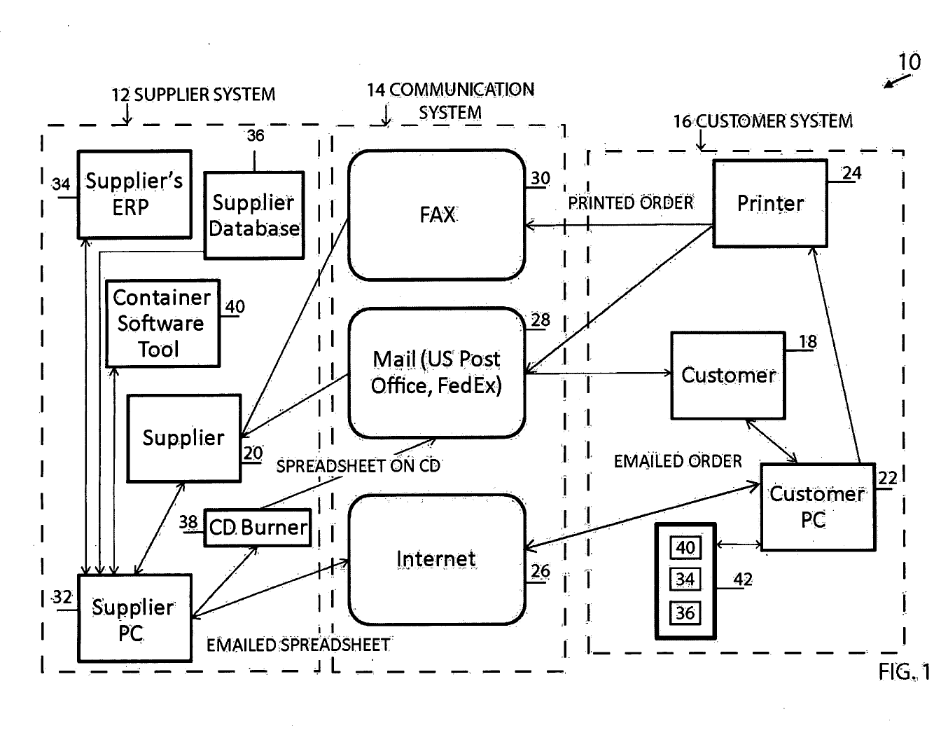

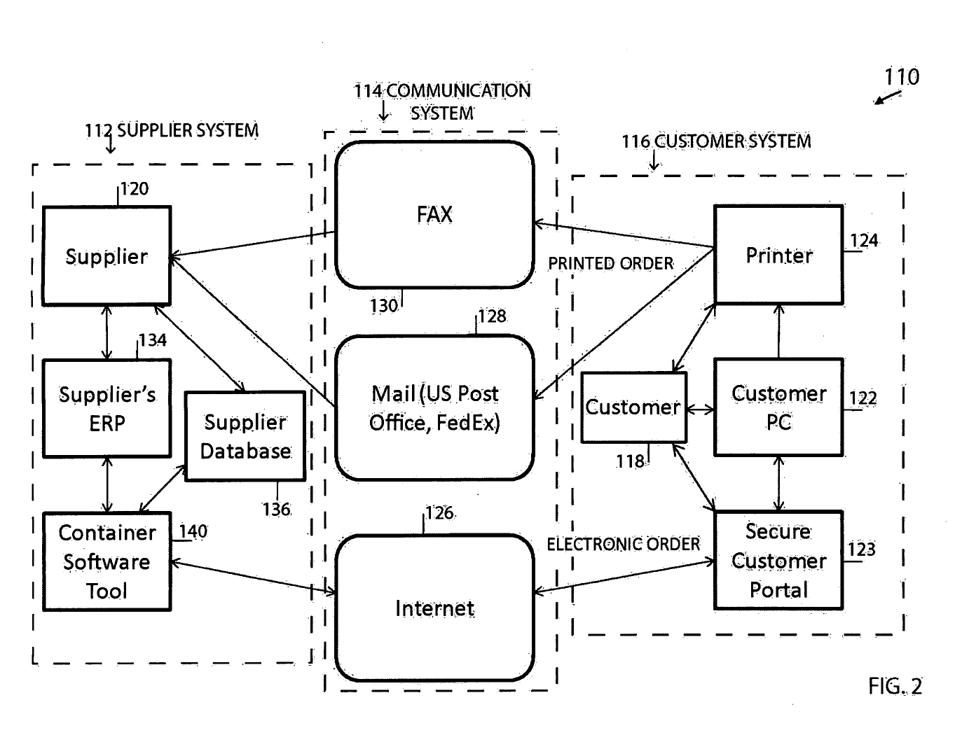

FIGS. 1 and 2 show a spreadsheet-based system for implementing the present invention and a web-based system for implementing the present invention, respectively. Turning to FIG. 1, a spreadsheet-based system 10 comprises a supplier system 12, a communications system 14, and a customer system 16. The spreadsheet-based system 10 allows a customer 18 to order items from a supplier 20.

The communication system 14 includes the Internet 26, a mail system 28, and a facsimile system 30. The customer system 16 comprises a customer PC 22 and a customer printer 24. The customer PC 22 is connected to the customer printer 24 and to the Internet 26.

The supplier system 12 comprises a supplier PC 32, a supplier ERP system 34, supplier databases 36, a CD burner 38, and a container software tool 40. The supplier PC 32 runs the container software tool 40 in order to provide optimized container loading, optimized freight costs, continuous calculation of the item landed cost for each item ordered, continuous calculation of the net landed cost for each container order, and communication of ordering and shipping constraints to the customer 18 for the items ordered by the customer 18 from the supplier 20. In order to optimize container loading, to optimized freight costs, to calculate the item landed cost per item, and to calculate the net landed cost per container order, the container software tool 40 retrieves information from the supplier's ERP system 34 as well as from supplier databases 36 all connected to the supplier PC 32.

For the spreadsheet-based system for implementing the present invention of FIG. 1, the supplier 20 by means of the supplier PC 32 creates a file 42 including the container software tool 40 as well as the pertinent data from the supplier's ERP system 34 and the supplier databases 36. The file 42 is then transmitted to the CD burner 38 to create a CD with the file 42 for mailing via the mail system 28 to the customer 18. Alternatively, the supplier 20 may e-mail the file 42 to the customer 18. The customer 18 then loads the file 42, with information from the supplier's ERP system 34 as well as from supplier databases 36, onto the customer PC 22 so that the customer 18 can run the container software tool 40 as a stand-alone program.

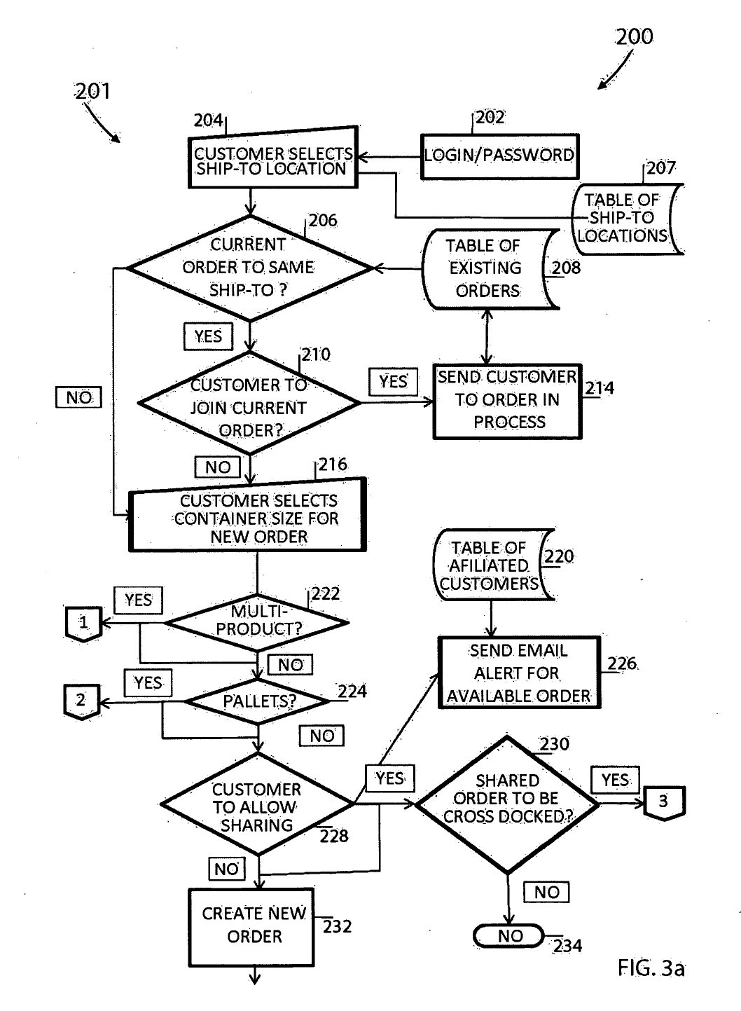

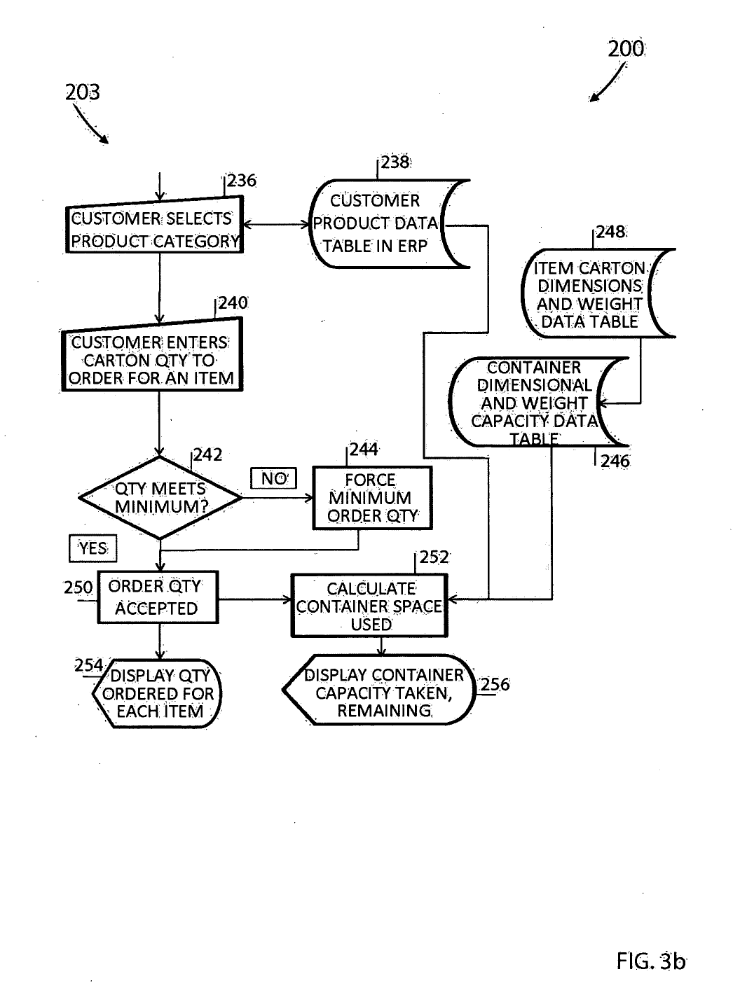

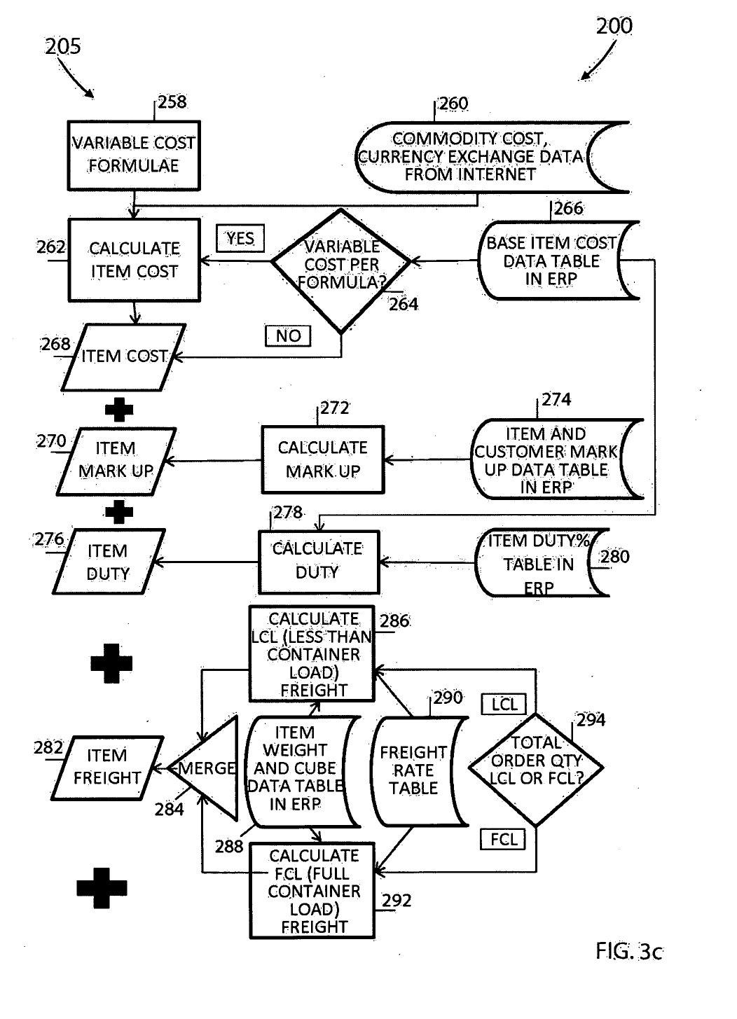

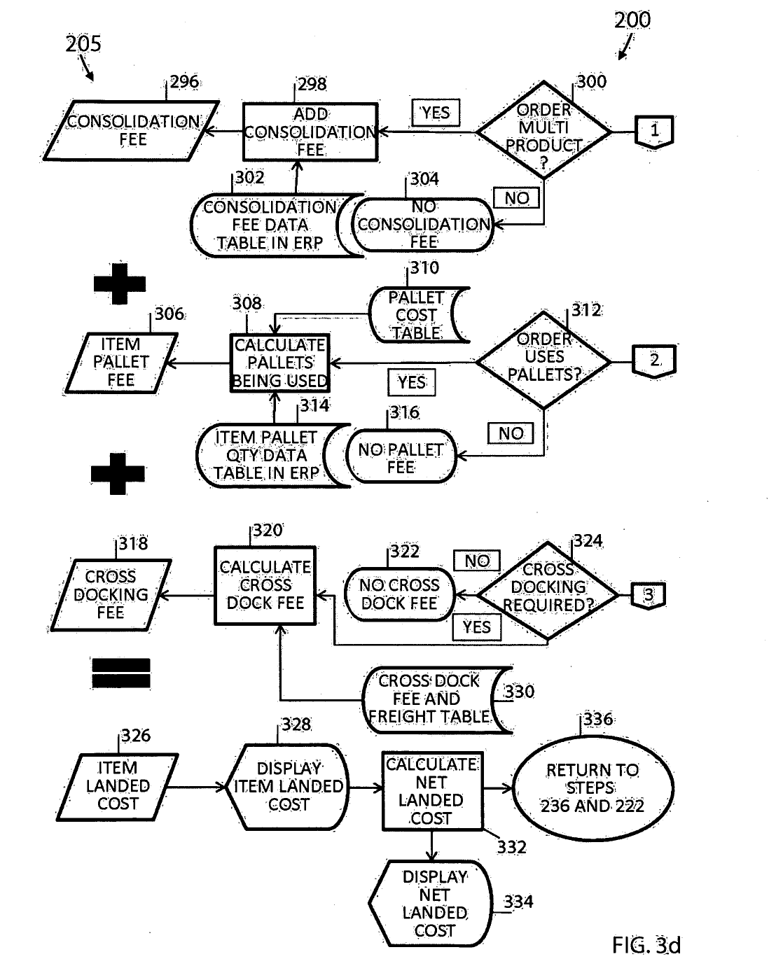

In operation, the customer 18 launches the container software tool 40 on the customer PC 22 and follows the menus and instructions provided by the container software tool 40 to configure a container order. The container software tool 40 running on the customer PC 22 implements the methods described in greater detail below in connection with FIGS. 3a-3d in order to optimize container loading, to optimize freight costs, to calculate the item landed cost of each item, and the net landed cost for a container order. Once the order has been configured by the container software tool 40, the configured order becomes the customer's purchase order, which can be transmitted to the supplier 20 either by the facsimile system 30, the mail system 28, or electronically via the Internet 26.

Turning to FIG. 2, a web-based system 110 comprises a supplier system 112, a communications system 114, and a customer system 116. The web-based system 110 allows a customer 118 to order items from a supplier 120.

The communication system 114 includes the Internet 126, a mail system 128, and a facsimile system 130. The customer system 116 comprises a customer PC 122, secure customer portal 123, and a customer printer 124. The customer PC 122 is connected to the customer printer 124 and to the Internet 126 via the secure customer portal 123.

The supplier system 112 comprises a supplier ERP system 134, supplier databases 136, and a container software tool 140. The container software tool 140 is run by the customer PC 122 over the Internet 126. As previously described, the container software tool 140 optimizes container loading, optimizes freight costs, calculates the item landed cost per item, calculates the net landed cost per container order, and communicates ordering and shipping constraints to the customer 118. In order to optimize container loading, to optimized freight costs, to calculate the item landed cost per item, and to calculate net landed cost per container order, the container software tool 140 retrieves information from the supplier's ERP system 134 as well as from supplier databases 136 all connected to the container software tool 140.

In operation, the customer 118, by means of customer PC 122, sets up a communication link through the secure customer portal 123 to Internet 126 in order to run the container software tool 140 over the Internet 126. The customer 118 then follows the menus provided by the container software tool 140. The customer 118 configures the container order by use of the container software tool 140. The container software tool 140 implements the methods described in greater detail below in connection with FIGS. 3a-3d in order to optimize container loading, to optimize freight costs, to calculate the item landed cost per item, to calculate the net landed cost per container order, and to communicate ordering and shipping constraints to the customer 118. Once the order has been configured by the container software tool 140, the configured order becomes the customer's purchase order, which can be transmitted to the supplier 120 either by the facsimile system 130, the mail system 128, or electronically via the Internet 126.

Order Configuration Logic

Turning to FIGS. 3a-3d, an order building method 200 implemented by the container software tool 140, FIG. 2 is illustrated. In order to optimize container loading, to optimize freight costs, to calculate the item landed cost per item, to calculate the net landed cost per container order, and to communicate ordering and shipping constraints to the customer, the order is configured in accordance with the following order configuration logic.

The order building method 200 includes order configuration sub-method 201 (FIG. 3a), order quantity sub-method 203 (FIG. 3b), and item landed cost sub-method 205 (FIGS. 3c and 3d). With reference to FIG. 3a and FIG. 2, the order configuration sub-method 201 begins at step 202, where the customer 118 logs onto the container software tool 140. Once the logon has been completed at step 202, the order configuration sub-method 201 proceeds to step 204, where the customer 118 selects the ship-to location from available locations designated by the supplier 120. The ship-to location is extracted from table 207 from the supplier's ERP system 134. The sub-method 201 proceeds from step 204 to step 206, where the sub-method 201 checks data table 208 for incomplete container orders that are being built for the same ship-to location and that were previously set up for shared containers. If an incomplete container order is being built and is available for sharing, the sub-method 201 follows the “yes” branch from step 206 to step 210. At step 210 the customer is given the option of joining the existing incomplete container order by following the “yes” branch to step 214. At step 214, the customer is presented the existing incomplete container order, and the customer can adopt that existing incomplete container order. If the customer decides not to adopt the existing incomplete container order, the sub-method 201 proceeds from step 210 to step 216. Alternatively, if at step 206 no incomplete container orders are found, the sub-method 201 proceeds to step 216.

At step 216, the customer selects the container size for the new container order. From step 216, the sub-method 201 proceeds to step 222, where the sub-method 201 determines whether multiple products have been ordered. If multiple products have been ordered, the sub-method 201 follows the “yes” branch from step 222 to sub-method “1” found in FIG. 3d for calculation of a consolidation fee. If on the other hand, multiple products have not been ordered, the sub-method 201 follows the “no” branch to step 224, where the sub-method 201 determines whether the ordered items are to be palletized or floor loaded. Floor loaded usually allows more total product but can take more labor to unload. If at step 224 the items are to be palletized, the sub-method 201 follows the “yes” branch from step 224 to sub-method “2” found in FIG. 3d for the calculation of a pallet fee. If on the other hand, the items are not to be palletized, the sub-method 201 proceeds from step 224 along the “no” branch to step 228, where the sub-method 201 determines whether the container order has been designated by the customer for sharing with another customer. If the container order has been designated for sharing with another customer, the sub-method 201 follows the “yes” branch from step 228 to step 230, where the sub-method 201 determines whether the shared container order is to be cross docked (i.e. the container received at a central warehouse in the importing country and portions of the container load re-shipped to multiple locations selected by the customer). Also from step 228, the “yes” branch sends an e-mail alert to potential shared customers identified at step 226 from a table 220 of the supplier's ERP system 134. Further, the “yes” branch of step 228 proceeds to step 232. For shared container orders that are to be cross docked at step 230, the sub-method 201 proceeds from step 230 to sub-method “3” in FIG. 3d for the calculation of a cross docking fee. For orders that do not require cross docking, the sub-method 201 proceeds from step 230 along the “no” branch to endpoint 234. If at step 228 the sub-method 201 determines that the customer has not designated the container order for sharing, the sub-method 201 proceeds along the “no” branch to step up 232, where a new container order is created. The order building method 200 then proceeds to step 236 of the order quantity sub-method 203 in FIG. 3b.

Turning to FIG. 3b, the order quantity sub-method 203 begins at step 236, where the customer selects a product category from which to order items. The product category is selected from table 238 in the supplier's ERP system 134. Sub-method 203 proceeds from step 236 to step 240, where the customer enters the carton quantity for the item ordered. From step 240, the sub-method 203 proceeds to step 242, where the sub-method 203 determines whether the quantity of the item input by the customer at step 240 meets the minimum order quantity designated by the supplier. If the quantity ordered does not meet the supplier's minimum order requirement, the sub-method 203 proceeds from step 242 along the “no” branch to step 244, where the sub-method 203 forces the minimum order quantity to the container order. From step 244, the sub-method 203 proceeds to step 250. If, on the other hand, the sub-method 203 determines at step 242 that the order meets the supplier's minimum quantity requirement, the sub-method 203 proceeds from step 242 along the “yes” branch to step 250. At step 250, the ordered quantity is accepted by the order quantity sub-method 203, and the sub-method 203 proceeds to step 254 where the quantity ordered is displayed to the customer.

Once the order quantity has been accepted at step 250, the sub-method 203 proceeds to step 252, where the sub-method 203 calculates the amount of container space used. The calculation at step 252 is based on the ordered quantity of items from step 250, the customer product data from table 238, item carton dimensions and weights from table 248, and the shipping container dimensions and weight capacity data from table 246. Once the space calculation is completed at step 252, the sub-method 203 proceeds to step 256 where the capacity of the shipping container occupied and the capacity of the shipping container remaining are displayed.

During the building of the customer order by order configuration sub-method 201 (FIG. 3a) and by order quantity sub-method 203 (FIG. 3b), the item landed cost sub-method 205 (FIGS. 3c and 3d) is continuously calculating and updating the item landed cost for each of the items ordered and the net landed cost of the container order. Turning to FIG. 3c, the item landed cost sub-method 205 begins by calculating the item cost for the ordered item. The calculation of the item cost begins at step 258, where a predefined variable cost formula is built based on cost data from table 260, such as currency exchange data, commodity cost data, or other cost adjustments announced by the supplier. Next the sub-method 205 extracts the base item cost from table 266 of the supplier's ERP system 134. If the variable cost formula is applied to the item cost, the sub-method 205 follows the “yes” branch from step 264 to step 262, where the item cost is calculated by applying the variable cost formula to the base item cost. The calculated item cost from the variable cost formula is stored at step 268. If the variable cost formula is not applied to the base item cost, the sub-method 205 follows the “no” branch from step 264 to step 268, where the base item cost from the table 266 is stored as the item cost.

The item markup cost is calculated at step 272 based on the item cost and customer markup data from table 274 of the supplier's ERP system 134. The calculated item markup cost is then stored at step 270.

The item duty cost is calculated at step 278 by extracting the item cost from table 266 of the supplier's ERP system 134 and the item duty percentage from table 280 of the supplier's ERP system 134. The calculated item duty cost is stored at step 276.

The item freight cost is calculated beginning at step 294 where the sub-method 205 determines whether the total order quantity is less than a container load (LCL) or it is a full container load (FCL). If at step 294 the sub-method 205 determines that the order quantity is less than a container load, the sub-method 205 follows the “LCL” branch to step 286, where the freight cost for an LCL is calculated based on the freight rates in table 290 and on the item weight and cube data in table 288 of the supplier's ERP system 134. If, on the other hand, at step 294 the sub-method 205 determines that the order quantity is a full container load, the sub-method 205 follows the “FCL” branch to step 292, where the freight cost for an FCL is calculated based on the freight rate in table 290 and on the item weight and cube data in table 288 of the supplier's ERP system 134. The calculations at step 286 and step 298 are then merged at step 284, and the resulting freight cost is stored at step 282.

Turning to FIG. 3d, the consolidation free is calculated beginning at step 300 of sub-method “1”, where the sub-method “1” determines whether multiple products were ordered. If multiple products were not ordered, the sub-method “1” follows the “no” branch to endpoint 304, indicating that no consolidation fee is required. If, on the other hand, a consolidation fee is required, the sub-method “1” follows the “yes” branch from step 300 to step 298, where the consolidation fee is determined by extracting the consolidation fee from table 302 of the supplier's ERP system 134. The consolidation fee calculated at step 298 is then stored at step 296.

The pallet fee is calculated beginning at step 312 of sub-method “2”, where the sub-method “2” determines whether the container order requires a pallet. If the container order does not require a pallet based on the customer's selection, the sub-method “2” proceeds along the “no” branch to endpoint 316, indicating no pallet fee is required. If, on the other hand, the container order does require a pallet based in the customer's selection, the sub-method “2” proceeds along the “yes” branch to step 308, where the pallet fee is calculated based on the flat fee data from table 314 of the supplier's ERP system 134. The pallet fee calculated at step 308 is stored at step 306.

The cross docking fee is calculated beginning at step 324 of sub-method “3”, where the sub-method “3” determines whether the container order requires cross docking. If the container order does not require cross docking based on the customer's selection, the sub-method “3” proceeds along the “no” branch to endpoint 322, indicating no cross docking fee is required. If, on the other hand, the container order does require cross docking based in the customer's selection, the sub-method “3” proceeds along the “yes” branch to step 320, where the cross docking fee is calculated based on the cross docking fee and freight rates data from table 330 of the supplier's ERP system 134. The cross docking fee calculated at step 320 is stored at step 318.

The item landed cost is calculated by summing the item cost 268, the item markup cost 270, the item duty 267, the item freight cost 286, the consolidation fee 296, the item pallet fee 306, and the cross docking fee 318. The resulting sum, the item landed cost, is stored at step 326 and displayed at step 328. The sub-method 205 then proceeds to step 332, where the sub-method 205 calculates the net landed cost for the container order. The net landed cost of the container order is then displayed at step 334. From step 332, the sub-method 205 proceeds to step 336, where the order building method 200 returns to steps 236 and 222 for entry of the next order item and the continuous update of the calculations for the item landed cost per item and the net landed cost per container order.

Table 1 below shows the organization of the data stores, the customer inputs, and the calculations carried out by the container software tool 40 (140).

TABLE 1

| DATA STORES | | INPUTS | |
|---|---|---|---|
| Supplier ERP | Supplier Database | User Inputs | CALCULATIONS |
| Project | Customer Class and | Username | Total Weight |
| | Mark-up | | |
| Item Number | Other part Number | Password | Total cubic meters (CBM) |
| Item Description | Carton MOQ | Order Status | Consolidation Fee |
| Unit Of Measure | Duty % | Freight Option | Pallet Fee |
| Item Cost | Item Pallet QTY | Destination | Net Landed Price |
| Carton QTY | Freight rates | Product Option | % Available |
| Carton Length | | Load Option | % Filled |
| Carton Width | | Order Name | Pallet Count |
| Carton Height | | Customer PO | Container Weight |
| | | Number | Available |
| Gross Weight | | Contact Name | Pallets Available |
| Item Duty % | | Contact Phone | Total Cartons Ordered |
| | | Number | |
| Customers | | Ship To Address | Total Pieces Ordered |
| Customer | | China or Vietnam | Total Net Landed Price |
| Address | | | |
| Price Level | | Select Project | Total Market Price |
| (Mark Up) | | Groups | |
| Vendor | | Order QTY in | Total Duty |
| | | Cartons | |
| Item Type | | Email Address | Allowance if Buying |
| | | | Group Member |
| | | Fax Number | Total Net Landed |
| | | | Amount by Product |
| | | | Total Overall Cost of |
| | | | Container |
| | | | % of Weight |
| | | | % of Volume |
| | | | LCL Calculations |

Table 1 below shows the parameters that are hard coded into the container software tool 40.

TABLE 2
Hard Coded Parameters

| 20 Foot Container | 40 Foot Container |
|---|---|
| Total Weight Avail for Floor | Total Weight Avail for Floor |
| loaded 20′ | loaded 40′ |
| Total Weight Avail for Palletized 20′ | Total Weight Avail for Palletized |
| | 40′ |
| Fill Factor % 20′ | Fill Factor % 40′ |
| Palletized Available Cubic Meters 20′ | Palletized Available Cubic Meters |
| | 40′ |
| Pallet Cubed Volume(Meters) 20′ | Pallet Cubed Volume(Meters) 40′ |
| Total Number of Pallets 20′ | Total Number of Pallets 40′ |
| Average Weight of Pallets 20′ | Average Weight of Pallets 40′ |
| Container Fill Factor 20′ | Container Fill Factor 40′ |
| Total Cubic Meters Available 20′ | Total Cubic Meters Available 40′ |
| Minus Fill Factor 20′ | Minus Fill Factor 40′ |
| Total Cubic Meters Floor Loaded 20′ | Total Cubic Meters Floor Loaded |
| | 40′ |
| Total Cubic Meters Palletized 20′ | Total Cubic Meters Palletized 40′ |
| Avg Pallet Volume 20′ | Avg Pallet Volume 40′ |

While this invention has been described with reference to preferred embodiments thereof, it is to be understood that variations and modifications can be affected within the spirit and scope of the invention as described herein and as described in the appended claims.

What is claimed is:

1. A method for building a container order for a shipping container, where in response to the selection of a ship-to location, of a shipping container, and of a quantity of an item by a customer, the method comprises:
a. identifying a constraint for at least one of the ship-to location and of the item, and communicating the constraint to the customer;
b. calculating the capacity utilization for the shipping container for the quantity of the selected item; and
c. calculating and displaying a cost of the item selected for shipping in the shipping container.

2. The method of claim 1, wherein calculating and displaying the cost of the item selected for shipping in the container includes:
a. calculating and displaying an item landed cost per item while the order is being built; and
b. calculating and displaying a net landed cost per container order while the order is being built.

3. The method of claim 1, wherein the method further comprises creating a purchase order incorporating the selected ship-to location, the selected shipping container, the selected quantity of the item, the cost of the item.

4. The method of claim 1, wherein the constraint for the ship-to location includes identifying existing incomplete container orders for the same ship-to location and offering the customer the option of joining at least one of the existing incomplete container orders.

5. The method of claim 1, wherein the constraint for the ship-to location includes identifying the container order as available for sharing.

6. The method of claim 1, wherein the constraint for the item includes identifying that the selected quantity of the item is less than a minimum order requirement for the item and forcing the quantity for the container order to the minimum order requirement for the item.

7. The method of claim 1, wherein calculating the space utilization includes calculating and displaying an amount of occupied space in the container and an amount of remaining, unfilled space in the container.

8. The method of claim 2, wherein calculating the item landed cost per item includes summing item cost and freight cost.

9. The method of claim 8, wherein calculating item landed cost per item further includes summing item markup cost and duty.

10. The method of claim 9, wherein calculating item landed cost per item further includes determining whether a consolidation fee is applicable to the container order, and if so, calculating the consolidation fee, determining whether a pallet fee is applicable to the container order, and if so, calculating the pallet fee, and determining whether a cross docking fee is applicable to the container order, and if so, calculating the cross docking fee and summing a consolidation fee, the pallet fee, and the cross docking fee.

11. The method of claim 8, wherein the item cost is calculated by applying a predetermined variable cost formula to the base item cost of the item.

12. The method of claim 8, wherein the freight cost is calculated by determining whether the quantity of items constitutes less than a container load and applying freight rates based on a container with less than a container load.

13. The method of claim 8, wherein the freight cost is calculated by determining whether the quantity of items constitutes a full container load and applying freight rates based on a container with a full container load.

14. The method of claim 9, wherein the markup cost is calculated based on data from a markup table.

15. The method of claim 9, wherein the duty is calculated as a percentage of the item cost.

16. The method of claim 10, wherein the consolidation fee is calculated based on data from a consolidation fee table.

17. The method of claim 10, wherein the pallet fee is calculated based on data from a pallet fee table.

18. The method of claim 10, wherein the cross docking fee is calculated based on data from a cross docking fee table and allocating the cross docking fee to each item based on the item's contribution to weight or volume of a partial cross docking shipment.

19. The method of claim 2, wherein calculating the net landed cost per container order includes multiplying in the quantity of items by the item landed cost per item.
